(19) United States
(12) Patent Application Publication
(10) Pub. No.: US 2026/0174001 A1
(43) Pub. Date: Jun. 25, 2026

(54) AGRICULTURAL PRODUCT FLOW MONITORING SYSTEM FOR AN AGRICULTURAL SYSTEM

(71) Applicant: CNH Industrial Canada, Ltd., Saskatoon (CA)

(72) Inventor: Trevor Lawrence Kowalchuk, Saskatoon (CA)

(21) Appl. No.: 19/000,840

(22) Filed: Dec. 24, 2024

(51) Int. Cl. A01C 7/10

(52) U.S. Cl. CPC A01C 7/105

(57) ABSTRACT

An agricultural product flow monitoring system for an agricultural system includes a flow sensor configured to be coupled to a seed boot of a row unit of the agricultural system. The flow sensor is configured to output a sensor signal indicative of agricultural product flow through the seed boot. The agricultural product flow monitoring system also includes a controller communicatively coupled to the flow sensor, in which the controller includes a memory and a processor. The controller is configured to receive the sensor signal from the flow sensor, to identify absence of the agricultural product flow in response to determining the agricultural product flow through the seed boot is not present, and to output a control signal in response to identifying the absence of the agricultural product flow.

### BACKGROUND

The present disclosure relates generally to an agricultural product flow monitoring system for an agricultural system.

Generally, agricultural seeding implements are towed behind a work vehicle, such as a tractor. The agricultural seeding implement may include multiple rows of ground engaging opener assemblies to excavate trenches into soil for depositing an agricultural product, such as seed or fertilizer. An air cart may be towed behind or in front of the agricultural seeding implement, in which the air cart is configured to provide the agricultural product to the ground engaging opener assemblies. In this manner, rows of the agricultural product may be deposited into the soil.

The agricultural product may be pneumatically conveyed from the air cart to the ground engaging opener assemblies via distribution lines (e.g., primary lines, secondary lines, tertiary lines, etc.). For example, the air cart may include an air source configured to output an air flow, and multiple primary lines may extend from the air source. A metering system positioned downstream from the air source may meter the agricultural product into the primary lines, and the air flow may fluidize and convey the agricultural product through each primary line to a respective header. The agricultural product may then flow from each header through multiple secondary lines toward respective ground engaging opener assemblies. Unfortunately, during operation of the agricultural seeding implement, at least one distribution line (e.g., at least one secondary line) may become clogged with the agricultural product, thereby blocking flow of the agricultural product to one or more respective ground engaging opener assemblies.

### BRIEF DESCRIPTION

In certain embodiments, an agricultural product flow monitoring system for an agricultural system includes a flow sensor configured to be coupled to a seed boot of a row unit of the agricultural system. The flow sensor is configured to output a sensor signal indicative of agricultural product flow through the seed boot. The agricultural product flow monitoring system also includes a controller communicatively coupled to the flow sensor, in which the controller includes a memory and a processor. The controller is configured to receive the sensor signal from the flow sensor, to identify absence of the agricultural product flow in response to determining the agricultural product flow through the seed boot is not present, and to output a control signal in response to identifying the absence of the agricultural product flow.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural system having an agricultural seeding implement and an air cart;

FIG. 2 is a schematic diagram of an embodiment of an agricultural product flow monitoring system that may be employed within the agricultural system of FIG. 1;

FIG. 3 is a side view of an embodiment of a row unit that may be employed within the agricultural seeding implement of FIG. 1; and

FIG. 4 is a block diagram of an embodiment of a sensor assembly that may be employed within the agricultural product flow monitoring system of FIG. 2.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

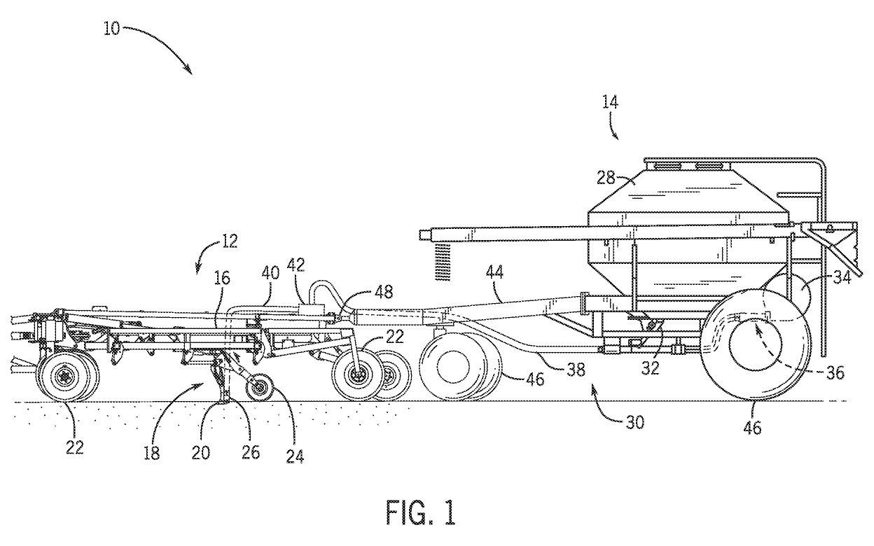

FIG. 1 is a side view of an embodiment of an agricultural system 10 having an agricultural seeding implement 12 and an air cart 14. In the illustrated embodiment, the agricultural seeding implement 12 includes a frame 16, and a row unit 18, which includes an opener 20, is coupled to the frame 16. As illustrated, wheel assemblies 22 are also coupled to the frame 16. The agricultural seeding implement 12 may be pulled through a field by a work vehicle (e.g., a tractor), and the agricultural seeding implement 12 may deposit rows of agricultural product (e.g., seed, fertilizer, inoculant, etc.) into the soil as the agricultural seeding implement 12 traverses the field. The wheel assemblies 22 contact the soil surface and enable the agricultural seeding implement 12 to be pulled by the work vehicle, and the row unit 18 may deposit one row of the agricultural product into the soil. Although only one row unit 18 is shown coupled to the frame 16 for clarity, the agricultural seeding implement 12 may include multiple row units 18 (e.g., organized in one or more rows across the agricultural seeding implement 12). In some embodiments, the agricultural seeding implement 12 may include 12, 14, 16, 18, 20, or more row units 18, each of which may deposit agricultural product into the soil to form a respective row.

To facilitate depositing the agricultural product within the soil, each row unit 18 includes the opener 20, a packer wheel 24, and a seed boot 26. In response to movement of the row unit 18 through the field, the opener 20 exerts a force onto the soil that excavates a trench within the soil. As the agricultural seeding implement 12 moves through the field, the row unit 18 may deposit the agricultural product into the excavated trench via the seed boot 26. Then, the packer wheel 24 may pack soil onto the deposited agricultural product.

In the illustrated embodiment, the air cart 14 includes at least one storage tank 28 configured to centrally store the agricultural product. In addition, the agricultural system 10 includes distribution lines 30 configured to facilitate flow of the agricultural product to the row units 18. Furthermore, the air cart 14 includes a metering system 32 configured to control flow of the agricultural product into the distribution lines 30. The air cart 14 also includes an air source 34 configured to provide an air flow through the distribution lines 30. The air flow interacts with the agricultural product flowing into the distribution lines 30 from the metering system 32, thereby fluidizing the agricultural product and forming an air/agricultural product mixture. The distribution lines 30 are configured to transport the air/agricultural product mixture to the row units 18, thereby providing the row units 18 with a metered flow of the agricultural product.

In the illustrated embodiment, the air cart 14 includes a plenum 36 coupled to the air source 34. The plenum 36 is configured to distribute the air flow provided by the air source 34 across multiple primary lines 38 of the distribution lines 30. The metering system 32 controls the flow of the agricultural product into the primary lines 38, and the air flow through the primary lines 38 fluidizes the agricultural product and conveys the agricultural product toward the row units 18. In addition, the distribution lines 30 include secondary lines 40 coupled to each primary line 38 via a respective distribution header 42. Each distribution header 42 is configured to distribute the air/agricultural product mixture provided by a respective primary line 38 to multiple secondary lines 40. In the illustrated embodiment, each secondary line 40 is coupled to a respective row unit 18. Accordingly, the agricultural product is conveyed from a storage tank 28 to the row units 18 via the primary lines 38, the distribution headers 42, and the secondary lines 40. However, in other embodiments, the agricultural system may include a secondary distribution header coupled to each secondary line, and multiple tertiary lines may be coupled to each secondary distribution header. In such embodiments, each tertiary line may be coupled to a respective row unit, such that the agricultural product is distributed via the primary lines, primary distribution headers, secondary lines, secondary distribution headers, and tertiary lines. Furthermore, in certain embodiments, the secondary lines and the distribution headers may be omitted, and the primary lines may be directly coupled to respective row units.

In the illustrated embodiment, the air cart 14 includes a frame 44 configured to support the storage tank(s) 28, the metering system 32, the air source 34, and the plenum 36. The air cart 14 also includes wheels 46 rotatably coupled to the frame 44 and configured to facilitate movement of the air cart 14 through the field. In the illustrated embodiment, the air cart 14 is towed behind the agricultural seeding implement 12. Accordingly, the agricultural seeding implement 12 is coupled to the work vehicle by a first hitch assembly, and the air cart 14 is coupled to the agricultural seeding implement 12 by a second hitch assembly 48. However, in other embodiments, the agricultural seeding implement may be towed behind the air cart. In further embodiments, the agricultural seeding implement and the air cart may be part of a single unit that is towed behind a work vehicle, or the agricultural seeding implement and the air cart may be elements of a self-propelled vehicle.

In certain embodiments, the agricultural system 10 includes an agricultural product flow monitoring system having a flow sensor and a controller. The flow sensor is coupled to a seed boot of a row unit 18 of the agricultural seeding implement 12, and the flow sensor is configured to output a sensor signal indicative of agricultural product flow through the seed boot. In addition, the controller is communicatively coupled to the flow sensor, and the controller includes a processor and a memory. The controller is configured to receive the sensor signal from the flow sensor, and the controller is configured to identify absence of the agricultural product flow in response to determining the agricultural product flow through the seed boot is not present. In addition, the controller is configured to output a control signal in response to identifying the absence of the agricultural product flow. For example, in certain embodiments, the control signal is indicative of instructions to control a user interface to present an indication of the absence of the agricultural product flow. Furthermore, in certain embodiments, the control signal is indicative of instructions to control the metering system 32 to terminate operation of a seed meter fluidly coupled to the seed boot. Because the flow sensor is coupled to the seed boot, a clog anywhere within the distribution lines 30 between the seed meter and the seed boot may be readily detected. For example, a clog within the respective secondary line proximate to the seed boot may be detected before a substantial amount of agricultural product accumulates within the secondary line (e.g., as compared to a configuration in which a flow sensor is positioned at the respective secondary line proximate to the respective distribution header). In addition, because the flow sensor is coupled to the seed boot, a disconnection anywhere within the distribution lines 30 between the seed meter and the seed boot may be detected. For example, disconnection of the respective secondary line from the seed boot may be detected (e.g., as compared to a configuration in which a flow sensor is positioned at the respective secondary line proximate to the respective distribution header).

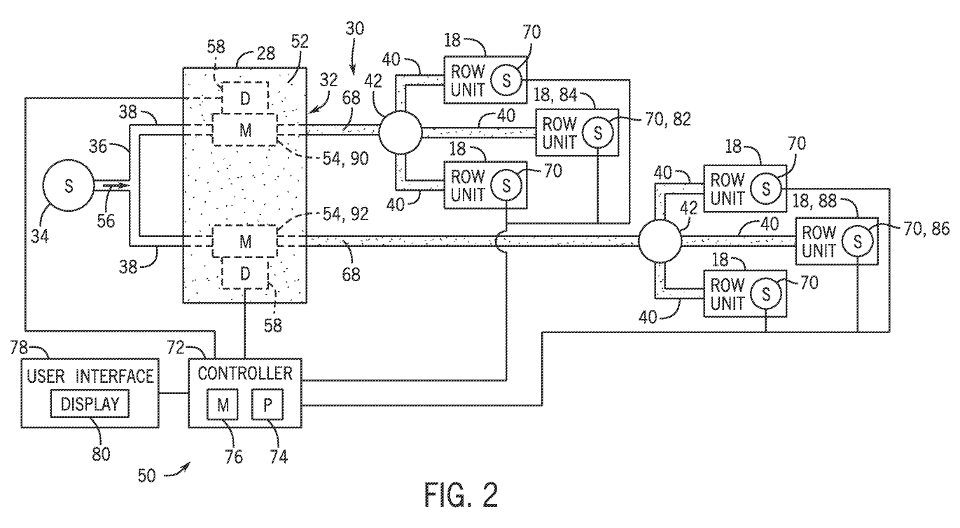

FIG. 2 is a schematic diagram of an embodiment of an agricultural product flow monitoring system 50 that may be employed within the agricultural system of FIG. 1. As previously discussed, the air source 34 is coupled to primary lines 38 of the distribution lines 30 via the plenum 36. The air source 34 may include fan(s), pump(s), blower(s), or a combination thereof, driven by suitable motor(s), such as electric motor(s), hydraulic motor(s), pneumatic motor(s), etc. Flowable agricultural product 52 (e.g., seed, fertilizer, etc.) within a storage tank 28 flows under the influence of gravity into the metering system 32. In certain embodiments, the storage tank 28 is pressurized such that a static pressure in the storage tank 28 is greater than a static pressure in the primary lines 38, thereby facilitating an even flow of the agricultural product through the metering system 32. However, in other embodiments, the storage tank may be unpressurized. In the illustrated embodiment, the metering system 32 includes two seed meters 54 (e.g., meter rollers) configured to control the flow of the agricultural product 52 into the air flow 56 output by the air source 34. Each seed meter 54 (e.g., meter roller) is housed within an individual meter box, and each seed meter 54 (e.g., meter roller) is configured to control flow of the agricultural product 52 into a respective primary line 38 for distribution to one or more respective row units of the agricultural seeding implement. By independently adjusting the rotation speed of each seed meter 54, flow of the particulate material to different portions of the agricultural seeding implement may be particularly controlled. While the metering system 32 includes two seed meters 54 in the illustrated embodiment, in other embodiments, the metering system may include more or fewer seed meters (e.g., 1, 3, 4, 5, 6, 7, 8, 9, 10, 11, 12, 13, 14, or more).

In the illustrated embodiment, each seed meter 54 (e.g., meter roller) is coupled to a respective drive assembly 58 of the metering system 32, and each drive assembly 58 is configured to drive the respective seed meter 54 (e.g., meter roller) to rotate, thereby facilitating independent control of the rotation rates of the seed meters 54. Each drive assembly 58 includes at least one drive unit, such as an electric or hydraulic motor, configured to drive the respective seed meter 54 to rotate. While each seed meter 54 is independently driven to rotate by a respective drive assembly 58 in the illustrated embodiment, in other embodiments, a single drive assembly may be configured to drive all of the seed meters to rotate together. Furthermore, in certain embodiments, the drive assembly may be omitted, and the seed meters may be coupled to a wheel (e.g., via a gear assembly), such that rotation of the wheel drives the seed meters to rotate.

In certain embodiments, each seed meter includes a meter roller having multiple flutes and corresponding recesses, in which the flutes and corresponding recesses are configured to meter the flowable agricultural product via rotation of the meter roller. Each recess is disposed between a respective pair of flutes. As the meter roller rotates, the respective pair of flutes moves the flowable agricultural product disposed within the respective recess downwardly, thereby transferring the flowable agricultural product 52 to the respective primary line 38. The number and geometry of the flutes may be particularly configured to accommodate the agricultural product being distributed. Certain meter rollers may include six flutes and a corresponding number of recesses. Other meter rollers may include more or fewer flutes and/or recesses. For example, the meter roller may include 1, 2, 3, 4, 5, 6, 7, 8, 9, 10, 11, 12, 13, 14, 15, 16, 17, 18, 19, 20, or more flutes and/or recesses. In addition, the depth of the recesses and/or the height of the flutes may be configured to accommodate the agricultural product metered by the meter roller. For example, a meter roller having deeper recesses and fewer flutes may be employed for larger seeds, while a meter roller having shallower recesses and more flutes may be employed for smaller seeds. Other parameters, such as flute pitch (i.e., angle of the flute relative to a longitudinal/rotational axis of the meter roller) and flute angle (i.e., angle of the flute relative to a radial axis of the meter roller), may also be particularly selected to accommodate the flowable agricultural product. While seed meters including meter rollers are disclosed above, in certain embodiments, at least one seed meter (e.g., each seed meter) may include any other suitable device (e.g., auger) configured to control flow of the agricultural product via rotation of the seed meter.

For a particular seed meter configuration (e.g., meter roller profile), the rotation rate of the seed meter 54 (e.g., meter roller) controls the flow of the agricultural product 52 into the air flow 56. For example, as each seed meter 54 rotates, the seed meter 54 transfers the agricultural product through an opening in the metering system 32 into the respective primary line 38. The agricultural product then mixes with air from the air source 34, thereby forming an air/agricultural product mixture 68. The mixture then flows to the respective row unit(s) 18 of the agricultural seeding implement, where the flowable agricultural product (e.g., seed and/or fertilizer) is deposited within the soil.

In the illustrated embodiment, the distribution lines 30 include two primary lines 38. However, in embodiments with more or fewer seed meters, the distribution lines may include a number a primary lines equal to the number of seed meters. For example, in certain embodiments, the metering system may have a single seed meter, and the distribution lines may include a single primary line. Furthermore, in the illustrated embodiment, each primary line 38 is coupled to a respective distribution header 42, and three secondary lines 40 extend from each distribution header 42 to three respective row units 18. Accordingly, the primary lines 38, the distribution headers 42, and the secondary lines 40 direct the air/agricultural product mixture 68 to the row units 18. While the distribution lines 30 include three secondary lines 40 extending from each distribution header 42 in the illustrated embodiment, in other embodiments, the distribution lines may include more or fewer secondary lines extending from each distribution header to respective row unit(s). Furthermore, in certain embodiments, a secondary distribution header may be coupled to at least one secondary line, and tertiary lines may extend from the secondary distribution header to respective row units. In addition, in certain embodiments, at least one distribution header and the secondary lines extending from the at least one distribution header may be omitted. In such embodiments, each respective primary line may extend directly to a respective row unit.

Furthermore, in embodiments in which the air cart includes multiple tanks, the metering system may include one or more seed meters for each tank, and each seed meter may meter agricultural product from a respective tank to a respective primary line. For example, the air cart may include a first tank configured to store agricultural product (e.g., seed) and a second tank configured to store agricultural product (e.g., fertilizer). The metering system may include one or more first seed meters configured to meter agricultural product from the first tank to respective primary line(s), and the metering system may include one or more second seed meters configured to meter agricultural product from the second tank to respective primary line(s). In certain embodiments, each primary line may be configured to receive the agricultural product from the first tank via a respective first seed meter and the agricultural product from the second tank via a respective second seed meter. Furthermore, in certain embodiments, each primary line of one or more first primary lines may be configured to receive agricultural product from the first tank via a respective first seed meter, and each primary line of one or more second primary lines may be configured to receive agricultural product from the second tank via a respective second seed meter. In embodiments having first primary line(s) and second primary line(s), the distribution lines may include first secondary line(s) and second secondary line(s) and, in certain embodiments, first tertiary line(s) and second tertiary line(s).

In the illustrated embodiment, the agricultural product flow monitoring system 50 includes multiple flow sensors 70. Each flow sensor 70 is coupled to a seed boot of a respective row unit 18, and the seed boot of each row unit 18 is configured to engage the soil. In addition, each seed boot is fluidly coupled to a respective secondary line 40, and the seed boot is configured to receive the air/agricultural product mixture 68 from the respective secondary line 40. Accordingly, each seed boot is configured to receive the agricultural product from a seed meter 54 of the metering system 32 and to expel the agricultural product into the soil. Furthermore, each flow sensor 70 is configured to output a respective sensor signal indicative of flow of the agricultural product (e.g., agricultural product flow) through the respective seed boot.

In the illustrated embodiment, the agricultural product flow monitoring system 50 includes a controller 72 communicatively coupled to each flow sensor 70. In certain embodiments, the controller 72 is an electronic controller having electrical circuitry configured to receive the sensor signal from each flow sensor 70. In the illustrated embodiment, the controller 72 includes a processor 74, such as the illustrated microprocessor, and a memory device 76. The controller 72 may also include one or more storage devices and/or other suitable components. The processor 74 may be used to execute software, such as software for monitoring flow of the agricultural product, and so forth. Moreover, the processor 74 may include multiple microprocessors, one or more “general-purpose” microprocessors, one or more special-purpose microprocessors, and/or one or more application specific integrated circuits (ASICs), or some combination thereof. For example, the processor 74 may include one or more reduced instruction set (RISC) processors.

The memory device 76 may include a volatile memory, such as random access memory (RAM), and/or a nonvolatile memory, such as read-only memory (ROM). The memory device 76 may store a variety of information and may be used for various purposes. For example, the memory device 76 may store processor-executable instructions (e.g., firmware or software) for the processor 74 to execute, such as instructions for monitoring flow of the agricultural product, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for monitoring flow of the agricultural product, etc.), and any other suitable data. The controller may be positioned at any suitable location(s) on the agricultural system (e.g., on the air cart and/or on the agricultural seeding implement) and/or on the work vehicle coupled to the agricultural system (e.g., as one element in one location or as multiple elements in multiple locations).

In the illustrated embodiment, the agricultural product flow monitoring system 50 includes a user interface 78 communicatively coupled to the controller 72. The user interface 78 is configured to receive input from an operator and to provide information to the operator. The user interface 78 may include any suitable input device(s) for receiving input, such as a keyboard, a mouse, button(s), switch(es), knob(s), other suitable input device(s), or a combination thereof. In addition, the user interface 78 may include any suitable output device(s) for presenting information to the operator, such as speaker(s), indicator light(s), other suitable output device(s), or a combination thereof. In the illustrated embodiment, the user interface 78 includes a display 80 configured to present visual information to the operator. In certain embodiments, the display 80 may include a touchscreen interface configured to receive input from the operator.

The controller 72 is configured to receive the sensor signal from each flow sensor 70, and the controller 72 is configured to identify absence of agricultural product flow in response to determining the agricultural product flow through the respective seed boot is not present. In addition, the controller 72 is configured to output a control signal in response to identifying the absence of the agricultural product flow. For example, in certain embodiments, the control signal is indicative of instructions to control the user interface 78 to present an indication (e.g., on the display 80) of the absence of the agricultural product flow through the respective seed boot. Furthermore, in certain embodiments, the control signal is indicative of instructions to control the metering system 32 to terminate operation of the seed meter 54 fluidly coupled to the respective seed boot, thereby terminating flow of the agricultural product to the seed boot. For example, the control signal may be indicative of instructions to control the respective drive assembly 58 of the metering system 32 to terminate operation of the respective seed meter 54. Because each flow sensor 70 is coupled to a respective seed boot, a clog anywhere within the distribution lines 30 may be readily detected. For example, a clog within a secondary line 40 proximate to a respective seed boot may be detected before a substantial amount of agricultural product accumulates within the secondary line 40 (e.g., as compared to a configuration in which a flow sensor is positioned at the respective secondary line proximate to the respective distribution header). In addition, because each flow sensor 70 is coupled to a respective seed boot, a disconnection anywhere within the distribution lines 30 may be detected. For example, disconnection of a secondary line 40 from a respective seed boot may be detected (e.g., as compared to a configuration in which a flow sensor is positioned at the respective secondary line proximate to the respective distribution header).

In the illustrated embodiment, a flow sensor 70 is coupled to the seed boot of each row unit 18 of the agricultural seeding implement. Accordingly, the controller 72 of the agricultural product flow monitoring system 50 may identify a location of the clog based on the sensor signals from the flow sensors 70. For example, if the controller 72 identifies absence of agricultural product flow through one seed boot, the controller 72 may determine that a clog or disconnection is present at the secondary line 40 coupled to the one seed boot. However, if the controller 72 identifies absence of agricultural product flow through all of the seed boots that receive the agricultural product from a respective primary line 38, the controller 72 may determine that a clog or disconnection is present at the respective primary line 38. While a flow sensor 70 is coupled to the seed boot of each row unit 18 of the agricultural seeding implement in the illustrated embodiment, in other embodiments, flow sensor(s) may not be coupled to the seed boot(s) of certain row unit(s).

By way of example, in the illustrated embodiment, the agricultural product flow monitoring system 50 includes a first flow sensor 82 coupled to a first seed boot of a first row unit 84, and the agricultural product monitoring system 50 includes a second flow sensor 86 coupled to a second seed boot of a second row unit 88. The first flow sensor 82 is configured to output a first sensor signal indicative of first agricultural product flow through the first seed boot, and the second flow sensor 86 is configured to output a second sensor signal indicative of second agricultural product flow through the second seed boot. The controller 72 is communicatively coupled to the first and second flow sensors, and the controller 72 is configured to receive the first and second sensor signals. Furthermore, the controller 72 is configured to identify absence of the first agricultural product flow in response to determining the first agricultural product flow through the first seed boot is not present, and the controller 72 is configured to identify absence of the second agricultural product flow in response to determining the second agricultural product flow through the second seed boot is not present. In addition, in certain embodiments, the controller 72 is configured to control the metering system 32 (e.g., a respective drive assembly 58 of the metering system 32) to terminate operation of a first seed meter 90 fluidly coupled to the first seed boot in response to identifying the absence of the first agricultural product flow, and the controller 72 is configured to control the metering system 32 (e.g., a respective drive assembly 58 of the metering system 32) to terminate operation of a second seed meter 92 fluidly coupled to the second seed boot in response to identifying the absence of the second agricultural product flow. Furthermore, in certain embodiments, the controller 72 is configured to control the user interface 78 to present a first indication (e.g., on the display 80) of the absence of the first agricultural product flow in response to identifying the absence of the first agricultural product flow, and the controller 72 is configured to control the user interface 78 to present a second indication (e.g., on the display 80) of the absence of the second agricultural product flow in response to identifying the absence of the second agricultural product flow.

While controlling the metering system in response to identifying absence of agricultural product flow is disclosed above, in certain embodiments, the controller may be configured to control gates (e.g., at the metering system and/or at header(s)) configured to selectively block flow of agricultural product to seed boots. For example, in response to identifying absence of the agricultural product flow through a seed boot, the controller may control a gate along a flow path to the seed boot to block the agricultural product from flowing to the seed boot. In certain embodiments, the metering system may include a single seed meter for each tank, and the distribution lines may include a single primary line for each seed meter. In addition, a header may be coupled to each primary line, and multiple secondary lines may be coupled to the header. The header may include a gate for each secondary line, and the controller may control the gates to control flow of the agricultural product to row units fluidly coupled to the secondary lines. For example, a secondary header may be coupled to each secondary line, and tertiary lines may extend from each secondary header to respective row units. Accordingly, the controller may control each gate to selectively block flow of agricultural product to row units fluidly coupled to the respective secondary line.

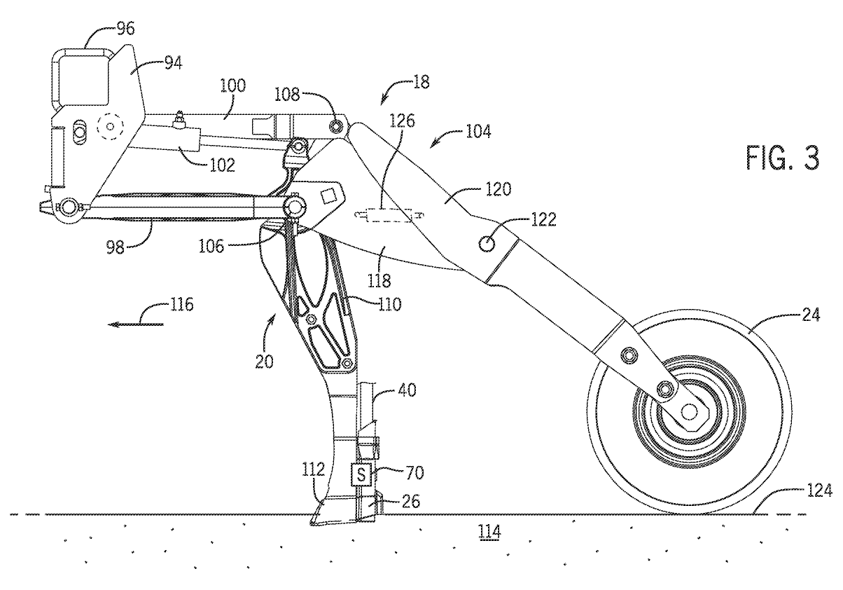

FIG. 3 is a side view of an embodiment of a row unit 18 that may be employed within the agricultural seeding implement of FIG. 1. As illustrated, the row unit 18 includes a frame support 94 and a mounting bracket 96. The frame support 94 and the mounting bracket 96 are configured to interface with a toolbar (e.g., of a respective tool frame), thereby securing the row unit 18 to the frame of the agricultural seeding implement. While the row unit 18 includes a single mounting bracket 96 in the illustrated embodiment, in other embodiments, the row unit may include multiple mounting brackets (e.g., 2, 3, 4, 5, 6, or more). Furthermore, while the row unit 18 is coupled to the toolbar by the frame support 94 and the mounting bracket(s) 96 in the illustrated embodiment, in other embodiments, the row unit may be coupled to the toolbar by any other suitable connection system (e.g., including fastener(s), a welded connection, an adhesive connection, etc.).

In addition, in the illustrated embodiment, the row unit 18 includes a first linkage member 98, a second linkage member 100, and a biasing device, such as the illustrated row unit downforce actuator 102. As illustrated, the first linkage member 98 (e.g., first link) and the second linkage member 100 (e.g., second link) extend from the frame support 94 to a packer wheel arm assembly 104. The first linkage member 98 is pivotally coupled to the frame support 94, thereby pivotally coupling the first linkage member 98 to the toolbar of the agricultural seeding implement. In addition, the first linkage member 98 is pivotally coupled to the packer wheel arm assembly 104 at a first pivot joint 106. In the illustrated embodiment, the second linkage member 100 is pivotally coupled to the frame support 94, thereby pivotally coupling the second linkage member 100 to the toolbar of the agricultural seeding implement. Furthermore, the second linkage member 100 is pivotally coupled to the packer wheel arm assembly 104 at a second pivot joint 108. Accordingly, the first and second linkage members form a linkage (e.g., parallel linkage) between the frame support 94 and the packer wheel arm assembly 104. While the linkage is formed by the first and second linkage members in the illustrated embodiment, in other embodiments, the packer wheel arm assembly may be coupled to the frame support by any other suitable type of linkage (e.g., a linkage including only the first linkage member, a linkage including only the second linkage member, etc.).

The row unit downforce actuator 102 is pivotally coupled to the frame support 94 and to a shank 110 of the opener 20 of the row unit 18. In addition, the shank 110 is pivotally coupled to the first linkage member 98 and to the packer wheel arm assembly 104 at the first pivot joint 106. A blade 112 of the opener 20 is rigidly coupled (e.g., non-movably coupled, non-rotatably coupled, non-translatably coupled, etc.) to the shank 110 and configured to engage the soil 114. The row unit downforce actuator 102 is configured to urge the packer wheel arm assembly 104 and the opener 20 to translate downwardly. Translational movement of the packer wheel arm assembly 104 and the opener 20 is controlled by the linkage. For example, the linkage may cause the packer wheel arm assembly 104 and the opener 20 to translate with respect to a vertical axis. The row unit downforce actuator 102 may include any suitable type(s) of actuation device(s), such as hydraulic cylinder(s), pneumatic cylinder(s), etc. Furthermore, while the biasing device includes the row unit downforce actuator 102 in the illustrated embodiment, in other embodiments, the row unit may include other suitable type(s) of biasing device(s), such as a spring or a pneumatic strut.

The blade 112 is configured to form a trench within the soil 114 as the row unit 18 moves along a direction of travel 116. In the illustrated embodiment, the row unit 18 includes a seed boot 26 coupled to the shank 110 and configured to direct agricultural product into the trench formed by the blade 112. As previously discussed, the seed boot 26 is configured to engage the soil 114, the seed boot 26 is fluidly coupled to a respective secondary line 40, and the seed boot 26 is configured to receive agricultural product from the respective secondary line 40. Accordingly, the seed boot 26 is configured to receive the agricultural product from a seed meter of the metering system and to expel the agricultural product into the soil 114. In the illustrated embodiment, the seed boot 26 includes a single passage (e.g., agricultural product tube) configured to direct the agricultural product from the secondary line 40 into the soil 114. However, in other embodiments, the seed boot may include multiple passages (e.g., 2, 3, or more) configured to direct multiple agricultural products from multiple secondary lines into the soil. Furthermore, while the seed boot 26 is coupled to the shank 110 in the illustrated embodiment, in other embodiments, the seed boot may be coupled to another suitable component of the row unit. As used herein, “seed boot” of a row unit refers to any part or assembly of parts positioned downstream from the most downstream line of the distribution lines (e.g., secondary line, tertiary line) and configured to engage the soil, receive agricultural product from the most downstream line, and to expel the agricultural product into the soil.

In the illustrated embodiment, the packer wheel arm assembly 104 includes a base 118 and a packer wheel arm 120 pivotally coupled to one another at a third pivot joint 122. The base 118 is pivotally coupled to the first linkage member 98 and to the second linkage member 100, and the packer wheel 24 is rotatably coupled to the packer wheel arm 120 of the packer wheel arm assembly 104. The packer wheel 24 rotates along a surface 124 of the soil 114 to both pack the soil on top of deposited agricultural product and to control the penetration depth of the blade 112. In the illustrated embodiment, the row unit 18 includes a packer wheel actuator 126 (e.g., depth control system) coupled to the base 118 and to the packer wheel arm 120 of the packer wheel arm assembly 104. The packer wheel actuator 126 is configured to control a position of the packer wheel 24 relative to the opener 20 to control the penetration depth of the blade 112 within the soil 114. For example, the packer wheel actuator 126 may drive the packer wheel arm 120 to rotate upwardly relative to the base 118 of the packer wheel arm assembly 104, thereby moving the packer wheel 24 upwardly relative to the opener 20. The force applied by the row unit downforce actuator 102 may enable the packer wheel 24 to maintain contact with the surface 124 as the packer wheel 24 moves upwardly relative to the opener 20, thereby causing the penetration depth of the blade 112 to increase. In addition, the packer wheel actuator 126 may drive the packer wheel arm 120 to rotate downwardly relative to the base 118 of the packer wheel arm assembly 104, thereby moving the packer wheel 24 downwardly relative to the opener 20. The force applied by the row unit downforce actuator 102 may enable the packer wheel 24 to maintain contact with the surface 124 as the packer wheel 24 moves downwardly relative to the opener 20, thereby causing the penetration depth of the blade 112 to decrease.

While the packer wheel actuator 126 is positioned proximate to the linkage members in the illustrated embodiment, in other embodiments, the packer wheel actuator may be positioned proximate to the packer wheel or at another suitable location along the packer wheel arm assembly. Furthermore, while the row unit 18 includes the packer wheel actuator 126 in the illustrated embodiment, in other embodiments, the row unit may include another suitable depth control system, such as a fastener/slot assembly, a fastener/apertures assembly, a rotating cam assembly, a mechanical stop/slide assembly, etc. In addition, while the opener 20 includes a single shank 110 in the illustrated embodiment, in other embodiments, the opener may include multiple shanks. For example, in certain embodiments, the opener may include a second shank and a second blade coupled to the second shank, in which the second shank is coupled (e.g., pivotally coupled) to the base of the packer wheel arm assembly. In addition, the row unit may include a second seed boot (e.g., coupled to the second shank) and configured to direct agricultural product into the trench formed by the second blade.

As illustrated, the flow sensor 70 of the agricultural product flow monitoring system is coupled to the seed boot 26. As previously discussed, the flow sensor 70 is configured to output a sensor signal indicative of flow of the agricultural product through the seed boot 26. Furthermore, the controller of the agricultural product flow monitoring system is configured to receive the sensor signal from the flow sensor 70. The controller is also configured to identify absence of agricultural product flow in response to determining the flow of the agricultural product through the seed boot 26 is not present, and the controller is configured to output a control signal in response to identifying the absence of the agricultural product flow.

In certain embodiments, the flow sensor 70 is coupled to the seed boot 26 via a removable connection. For example, the removable connection may be a threaded connection that enables the flow sensor 70 to be removed from the seed boot 26 via rotation of the flow sensor 70 relative to the seed boot 26. Furthermore, in certain embodiments, the removable connection may be a magnetic connection, a latched connection, a fastener connection, or another suitable type of removable connection. The removable connection enables the flow sensor 70 to be removed from the seed boot 26 to facilitate replacement of the seed boot 26. For example, the seed boot 26 may wear due to contact with the soil. Accordingly, the longevity of the seed boot 26 may be less than the longevity of the flow sensor 70. Accordingly, the removable connection between the flow sensor 70 and the seed boot 26 enables the flow sensor 70 to be removed from a worn seed boot 26 and coupled to a new seed boot 26. However, in certain embodiments, the flow sensor may be non-removably coupled to the seed boot (e.g., integrally formed with the seed boot).

In embodiments in which the row unit includes two seed boots, a flow sensor may be coupled to each seed boot and communicatively coupled to the controller. In addition, in embodiments in which at least one seed boot includes multiple passages, a flow sensor may be coupled to each passage and communicatively coupled to the controller. The controller may be configured to identify absence of the agricultural product flow through each passage in response to determining the flow of the agricultural product through the passage is not present, and the controller may output a control signal in response to identifying the absence of the agricultural product flow. For example, the control signal may be indicative of instructions to control the metering system to terminate operation of the seed meter fluidly coupled to the passage of the seed boot. Furthermore, while the agricultural product flow monitoring system is disclosed above with regard to an agricultural seeding implement having row units with shank/blade openers, the agricultural product flow monitoring system may be employed within an agricultural seeding implement having row units with other suitable openers. For example, in certain embodiments, each row unit of the agricultural implement may include a disc opener. In such embodiments, the seed boot may include a seed tube and an engagement element, in which the engagement element is configured to engage the disc opener. The flow sensor may be coupled to the seed tube, or the flow sensor may be coupled to the engagement element and positioned along an agricultural product flow path from an outlet of the seed tube to the soil. In addition, each row unit of the agricultural seeding implement (e.g., having a shank/blade opener, having a disc opener, etc.) does not include an agricultural product storage compartment (e.g., non-movably coupled to a component of the row unit), and each row unit of the agricultural seeding implement does not include a metering device (e.g., non-movably coupled to a component of the row unit). Instead, as previously discussed, the row units receive metered agricultural product from a common storage tank and a common metering system.

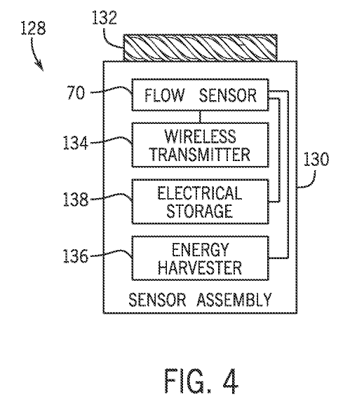

FIG. 4 is a block diagram of an embodiment of a sensor assembly 128 that may be employed within the agricultural product flow monitoring system of FIG. 2. In the illustrated embodiment, the sensor assembly 128 includes the flow sensor 70. The flow sensor 70 may include any suitable type(s) of sensing device(s) configured to monitor agricultural product flow through the seed boot. For example, in certain embodiments, the flow sensor 70 may include an infrared sensor, an ultrasonic sensor, a millimeter wave sensor, a capacitive sensor, an optical sensor, an impact (e.g., piezoelectric) sensor, an acoustical sensor, other suitable type(s) of sensing device(s), or a combination thereof. As previously discussed, the flow sensor is configured to output a sensor signal indicative of agricultural product flow through the seed boot. In certain embodiments, the sensor signal may be indicative of presence or absence of the agricultural product flow through the seed boot. Furthermore, in certain embodiments, the sensor signal may be indicative of a flow rate of the agricultural product through the seed boot.

In the illustrated embodiment, the sensor assembly 128 includes a housing 130, and the flow sensor 70 is disposed within the housing 130. The housing 130 may be formed from any suitable material(s) (e.g., metal, composite material, polymeric material, etc.). For example, in certain embodiments, the sensor assembly 128 may be coupled to the seed boot above a soil engaging portion of the seed boot, such that the sensor assembly 128 does not directly engage the soil. In such embodiments, the housing 130 may be formed from a lighter and/or thinner material. Furthermore, in certain embodiments, the sensor assembly may be coupled to the seed boot at the soil engaging portion of the seed boot, such that the sensor assembly directly engages the soil. In such embodiments, the housing 130 may be formed from heavier and/or thicker material. In addition, the housing 130 may include a port (e.g., opening) configured to enable the flow sensor 70 to monitor the agricultural product flow through the seed boot.

Furthermore, in the illustrated embodiment, the housing 130 includes a threaded protrusion 132 configured to engage a corresponding threaded recess within the seed boot, thereby removably coupling the sensor assembly 128 to the seed boot. For example, to couple the flow sensor 70 to the seed boot, the threaded protrusion 132 may be aligned with the threaded recess, and the sensor assembly 128 may be rotated to engage the threaded protrusion 132 with the threaded recess. In addition, to uncouple the flow sensor 70 from the seed boot, the sensor assembly 128 may be rotated to disengage the threaded protrusion 132 from the threaded recess. As previously discussed, the removable connection between the flow sensor 70 and the seed boot facilitates replacement of the seed boot without replacing the flow sensor 70. While the flow sensor 70 is removably coupled to the seed boot by a threaded connection in the illustrated embodiment, in other embodiments, the flow sensor may be removably coupled to the seed boot by another suitable type of removable connection, such as a magnetic connection, a latched connection, a fastener connection, or another suitable type of removable connection. Furthermore, in certain embodiments, the flow sensor may be non-removably coupled to the seed boot (e.g., the seed boot and the housing of the sensor assembly may be integrally formed).

In the illustrated embodiment, the sensor assembly 128 includes a wireless transmitter 134 communicatively coupled to the flow sensor 70. The wireless transmitter 134 is configured to establish a wireless connection between the flow sensor 70 and the controller, thereby communicatively coupling the flow sensor 70 to the controller via the wireless connection. In certain embodiments, a wireless receiver may be communicatively coupled to the controller and configured to receive a wireless signal output by the wireless transmitter. The flow sensor 70 may output the sensor signal indicative of the agricultural product flow through the seed boot to the wireless transmitter 134, and the wireless transmitter 134 may wirelessly output a corresponding sensor signal (e.g., wireless signal) to the controller (e.g., via the wireless receiver). As a result, the controller may receive the sensor signal from the flow sensor 70. The wireless transmitter 134 may use any standard wireless communication protocol, such as Bluetooth, Wi-Fi, etc., or the wireless transmitter 134 may use a proprietary communication protocol. While the sensor assembly 128 includes the wireless transmitter 134 in the illustrated embodiment, in certain embodiments, the sensor assembly may include a wireless transceiver configured to both output and receive wireless signals. In addition, while the flow sensor 70 is communicatively coupled to the controller via a wireless connection in the illustrated embodiment, in other embodiments, the flow sensor may be communicatively coupled to the controller via a wired connection.

In the illustrated embodiment, the sensor assembly 128 of the agricultural product flow monitoring system includes a energy harvester 136. The energy harvester 136 is electrically coupled to the flow sensor 70 and configured to provide the flow sensor 70 with electrical power. The energy harvester may include any suitable type(s) of energy harvesting device(s), such as a photovoltaic assembly, a piezoelectric assembly, an electromagnetic induction assembly, other suitable type(s) of energy harvesting device(s), or a combination thereof. While the sensor assembly 128 includes the energy harvester 136 in the illustrated embodiment, in other embodiments, the energy harvester may be omitted.

In the illustrated embodiment, the sensor assembly 128 of the agricultural product flow monitoring system includes an electrical storage system 138. The electrical storage system 138 is electrically coupled to the flow sensor 70 and configured to provide the flow sensor 70 with electrical power. The electrical storage system 138 may include any suitable type(s) of electrical storage device(s), such as one or more batteries, one or more capacitors, other suitable type(s) of electrical storage device(s), or a combination thereof. The electrical storage system 138 may provide electrical power to the flow sensor 70 alone or in combination with other suitable source(s), such as the energy harvester 136 and/or an external power source. For example, in certain embodiments, the energy harvester 136 may provide electrical power to the electrical storage system 138 while the energy harvester 136 is outputting excess electrical power (e.g., more than the electrical power used by the flow sensor 70), thereby charging the electrical storage system 138. In addition, the electrical storage system 138 may provide supplemental electrical power to the flow sensor 70 while the energy harvester 136 is outputting insufficient electrical power (e.g., less than the electrical power used by the flow sensor 70). While the sensor assembly 128 includes the electrical storage system 138 in the illustrated embodiment, in other embodiments, the electrical storage system may be omitted. In embodiments in which both the electrical storage system and the energy harvester are omitted, the flow sensor may receive electrical power from an external power source via a wired connection to the external power source.

In embodiments in which the sensor assembly 128 includes the wireless transmitter or transceiver and at least one of the electrical storage system or the energy harvester, the sensor assembly 128 may be coupled to the seed boot without a wired connection to another component of the agricultural system (e.g., external power source, controller). Accordingly, the duration and complexity associated with installing the flow sensors throughout the agricultural seeding implement (e.g., on all of the seed boots of the agricultural seeding implement) may be significantly reduced (e.g., as compared to providing at least one wired connection to each flow sensor). In addition, the duration and complexity of replacing worn seed boots (e.g., including removing the sensor assembly from the worn seed boot and coupling the sensor assembly to the new seed boot) may be significantly reduced (e.g., by obviating removal and reattachment of one or more wired connections).

In the illustrated embodiment, the flow sensor 70, the wireless transmitter 134, the electrical storage system 138, and the energy harvester 136 are disposed within the housing 130. In certain embodiments, at least one of the flow sensor, the wireless transmitter, the electrical storage system, or the energy harvester may not be disposed within the housing. For example, in certain embodiments, the housing may be omitted. In embodiments in which the flow sensor is not disposed within the housing, the flow sensor may be directly coupled (e.g., removably or non-removably) to the seed boot. For example, the flow sensor may include a threaded protrusion configured to engage a corresponding threaded recess within the seed boot. Furthermore, the flow sensor may be removably coupled to the seed boot by another suitable type of removable connection, such as a magnetic connection, a latched connection, a fastener connection, or another suitable type of removable connection.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…”, it is intended that such elements are to be interpreted under 35 U.S.C. 112(f). However, for any claims containing elements designated in any other manner, it is intended that such elements are not to be interpreted under 35 U.S.C. 112(f).

1. An agricultural product flow monitoring system for an agricultural system, comprising:
a flow sensor configured to be coupled to a seed boot of a row unit of the agricultural system, wherein the flow sensor is configured to output a sensor signal indicative of agricultural product flow through the seed boot; and
a controller communicatively coupled to the flow sensor, wherein the controller comprises a memory and a processor, and the controller is configured to:
receive the sensor signal from the flow sensor;
identify absence of the agricultural product flow in response to determining the agricultural product flow through the seed boot is not present; and
output a control signal in response to identifying the absence of the agricultural product flow.

2. The agricultural product flow monitoring system of claim 1, comprising a user interface communicatively coupled to the controller, wherein the control signal is indicative of instructions to control the user interface to present an indication of the absence of the agricultural product flow.

3. The agricultural product flow monitoring system of claim 1, wherein the control signal is indicative of instructions to control a metering system to terminate operation of a seed meter fluidly coupled to the seed boot.

4. The agricultural product flow monitoring system of claim 1, wherein the flow sensor is communicatively coupled to the controller via a wireless connection.

5. The agricultural product flow monitoring system of claim 1, comprising an energy harvester electrically coupled to the flow sensor and configured to provide the flow sensor with electrical power.

6. The agricultural product flow monitoring system of claim 1, comprising an electrical storage system electrically coupled to the flow sensor and configured to provide the flow sensor with electrical power.

7. The agricultural product flow monitoring system of claim 1, wherein the flow sensor is configured to couple to the seed boot via a removable connection.

8. An agricultural system, comprising:
a row unit comprising a seed boot, wherein the seed boot is configured to receive agricultural product from a seed meter of a metering system and to expel the agricultural product into soil; and
an agricultural product flow monitoring system, comprising:
a flow sensor coupled to the seed boot, wherein the flow sensor is configured to output a sensor signal indicative of flow of the agricultural product through the seed boot; and
a controller communicatively couple to the flow sensor, wherein the controller comprises a memory and a processor, and the controller is configured to:
receive the sensor signal from the flow sensor;
identify absence of agricultural product flow in response to determining the flow of the agricultural product through the seed boot is not present; and
output a control signal in response to identifying the absence of the agricultural product flow.

9. The agricultural system of claim 8, comprising the metering system, wherein the seed meter is fluidly coupled to the seed boot, and the control signal is indicative of instructions to control the metering system to terminate operation of the seed meter.

10. The agricultural system of claim 8, wherein the agricultural product flow monitoring system comprises a user interface communicatively coupled to the controller, and the control signal is indicative of instructions to control the user interface to present an indication of the absence of the agricultural product flow.

11. The agricultural system of claim 8, wherein the flow sensor is coupled to the seed boot via a removable connection.

12. The agricultural system of claim 8, wherein the flow sensor is communicatively coupled to the controller via a wireless connection.

13. The agricultural system of claim 8, wherein the agricultural product flow monitoring system comprises an energy harvester electrically coupled to the flow sensor and configured to provide the flow sensor with electrical power.

14. The agricultural system of claim 8, wherein the agricultural product flow monitoring system comprises an electrical storage system electrically coupled to the flow sensor and configured to provide the flow sensor with electrical power.

15. An agricultural product flow monitoring system for an agricultural system, comprising:
a first flow sensor configured to be coupled to a first seed boot of a first row unit of the agricultural system, wherein the first flow sensor is configured to output a first sensor signal indicative of first agricultural product flow through the first seed boot;
a second flow sensor configured to be coupled to a second seed boot of a second row unit of the agricultural system, wherein the second flow sensor is configured to output a second sensor signal indicative of second agricultural product flow through the second seed boot; and
a controller communicatively coupled to the first flow sensor and to the second flow sensor, wherein the controller comprises a memory and a processor, and the controller is configured to:
receive the first sensor signal from the first flow sensor;
receive the second sensor signal from the second flow sensor;
identify absence of the first agricultural product flow in response to determining the first agricultural product flow through the first seed boot is not present;
identify absence of the second agricultural product flow in response to determining the second agricultural product flow through the second seed boot is not present;
control a metering system to terminate operation of a first seed meter fluidly coupled to the first seed boot in response to identifying the absence of the first agricultural product flow; and
control the metering system to terminate operation of a second seed meter fluidly coupled to the second seed boot in response to identifying the absence of the second agricultural product flow.

16. The agricultural product flow monitoring system of claim 15, comprising a user interface communicatively coupled to the controller, wherein the controller is configured to control the user interface to present a first indication of the absence of the first agricultural product flow in response to identifying the absence of the first agricultural product flow, and the controller is configured to control the user interface to present a second indication of the absence of the second agricultural product flow in response to identifying the absence of the second agricultural product flow.

17. The agricultural product flow monitoring system of claim 15, wherein the first flow sensor is communicatively coupled to the controller via a first wireless connection, and the second flow sensor is communicatively coupled to the controller via a second wireless connection.

18. The agricultural product flow monitoring system of claim 15, comprising:
a first energy harvester electrically coupled to the first flow sensor and configured to provide the first flow sensor with first electrical power; and
a second energy harvester electrically coupled to the second flow sensor and configured to provide the second flow sensor with second electrical power.

19. The agricultural product flow monitoring system of claim 15, comprising:
a first electrical storage system electrically coupled to the first flow sensor and configured to provide the first flow sensor with first electrical power; and
a second electrical storage system electrically coupled to the second flow sensor and configured to provide the second flow sensor with second electrical power.

20. The agricultural product flow monitoring system of claim 15, wherein the first flow sensor is configured to couple to the first seed boot via a first removable connection, and the second flow sensor is configured to couple to the second seed boot via a second removable connection.
